(19) United States
(12) Patent Application Publication
(10) Pub. No.: US 2005/0229407 A1
(43) Pub. Date: Oct. 20, 2005

(54) Curved saw

(75) Inventor: Kuniyuki Kanzawa, Miki-shi (JP)

Correspondence Address: KODA & ANDROLIA, 2029 CENTURY PARK EAST, SUITE 1140, LOS ANGELES, CA, 90067, US

(73) Assignee: Kanzawa Seiko Co., Ltd.

(21) Appl. No.: 10/891,204

(22) Filed: Jul. 14, 2004

(30) Foreign Application Priority Data
Apr. 15, 2004 (JP) 2004-119829

(51) Int. Cl. B26B 9/02

(52) U.S. Cl. 30/355

(57) ABSTRACT

A curved saw having a saw blade 1 curved from the back end to the front end. A multitude of saw teeth 2 are formed on the concave edge of the curved saw blade 1 in such a way that angles α of tooth flanks 3 near the back end of the saw blade 1 with respect to the edge line 5, which connects the tooth tips 4 of the saw teeth, are relatively larger than angles α of tooth flanks 3 near the front end of the saw blade 1 with respect to the edge line 5.

### BACKGROUND OF THE INVENTION

1. Field of the Invention

The present invention relates to a curved saw and more particularly to shapes of teeth of a curved saw with a curved blade having a multitude of saw teeth formed on its concave edge.

2. Prior Art

When pruning a standing tree or a fruit tree using a pruning saw, the saw teeth have to be pressed against the material to be cut for effective pruning. At this time, a pruning saw having saw teeth arranged on a straight line requires a large effort to cut the material because the front end of the blade has to be pressed hard against the material. As a result, people tend to cut the material using only the back end of the blade. This is inconvenient when pruning out-of-reach branches using a saw blade attached to the front end of a long handle, because it is difficult to press the saw blade hard against the material. As a means for solving this problem, a curved saw having a curved blade and a multitude of saw teeth formed on its concave edge is known. When the saw teeth positioned near the back end of the blade of a curved saw are placed on the material to be cut and the blade is pulled, the contact position between the material and the saw teeth shifts gradually toward the front end of the blade. Conversely the teeth arranged forward of the contact position move toward the material to be cut. In this way, it is easy to maintain the cutting condition of the saw teeth.

Japanese Utility Model Application Laid-Open (Kokai) H1-118641 discloses an invention relating to shapes of teeth of a curved saw.

More specifically, the above prior art discloses a concept of a curved saw in which the angle of the tooth back, i.e., the tooth flank, with respect to the center line of the curve radius of the edge line, i.e., the line that connects the tooth tips, is topologically changed in such a way that it becomes gradually smaller from the back end to the front end of the blade. This concept aims at avoiding the situation that the teeth closer to the front end of the blade do not adequately bite the material to be cut.

In a conventional curved saw as shown in FIG. 7, the angle α of the tooth flank 3 of each tooth 2 with respect to the edge line 5, i.e., the line that connects the tooth tips 4, is the same for all of the teeth that are arranged from the back end to the front end of the saw blade 1. Because of this arrangement, the cutting condition by the teeth closer to the back end may be different from the cutting condition by the teeth closer to the front end.

More specifically, while the part of the blade 1 that is closer to the back end can make a smooth reciprocal movement along the direction of the edge line of the back end portion of the blade and perform normal cutting, the part of the blade 1 that is closer to the front end tends to move in directions that cross the edge line 5. As a result, the tip of each tooth 2 acts on the material to be cut in such a way that it pierces it, making it difficult or impossible to perform a smooth cutting operation. Therefore in reality, not all teeth of the saw blade are used but only the teeth near the back end of the saw blade are used to cut the material by reciprocating the saw in short strokes.

In the above described prior art, the teeth near the front end of the saw blade tend to bite the material more strongly than the teeth near the back end of the saw blade, and this makes it difficult to perform a smooth cutting operation.

### SUMMARY OF THE INVENTION

In light of the foregoing, it is an object of the present invention to provide a curved saw in which all teeth thereof are effectively used to cut objects more smoothly.

In order to achieve the above object, the curved saw of the present invention is provided with a saw blade 1 that curves from its back end to its front end. A multitude of saw teeth 2 are formed on the concave edge of the curved saw blade 1. Angles α of tooth flanks 3 with respect to the edge line 5, which connects the tooth tips 4 of the saw teeth 2, near the back end of the saw blade 1 are relatively larger than angles α of tooth flanks 3 with respect to the edge line 5, which connects the tooth tips 4 of the saw teeth 2, near the front end of the saw blade.

In the above structure, angles α of tooth flanks 3 formed on the concave edge decrease progressively from the largest at the back end to the smallest at the front end of the blade.

Furthermore, in the present invention, the teeth arranged on the concave edge from the back end to the front end of the blade are divided into several sections Xn, and angles α of tooth flanks 3 with respect to the edge line, which connects the tooth tips 4 of the saw teeth 2, are varied from one section to another.

### BRIEF DESCRIPTION OF THE DRAWINGS

FIG. 1 is a front view of the entire body of a saw blade, illustrating an embodiment of a curved saw according to the present invention;

FIG. 2 is a section view of the material being cut by the back end of the saw blade shown in FIG. 1;

FIG. 3 is a section view of the material being cut by the front end of the saw blade shown in FIG. 1;

FIGS. 4(a) and 4(b) are schematic front views of saw blades according to another embodiment of the present invention;

FIG. 5 is a front view showing a part of an example of a high-branch pruning saw that is an example of the curved saw;

FIG. 6 is a front view of a curved saw of the present invention showing various stages of the material being cut by the saw teeth; and

FIG. 7 is a front view of the entire body of a saw blade, illustrating an example of a conventional type curved saw.

### DETAILED DESCRIPTION OF THE INVENTION

Preferred embodiments of the curved saw according to the present invention will now be described with reference to the accompanying drawings.

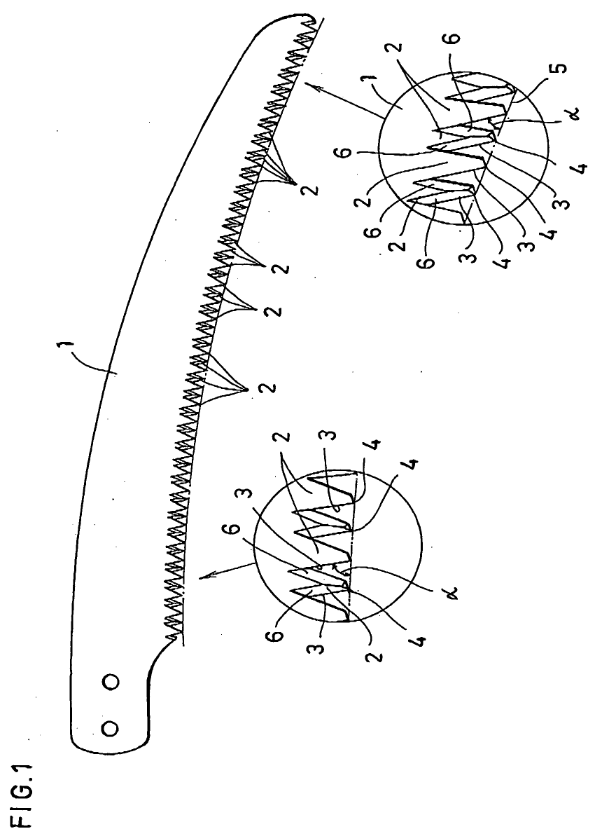

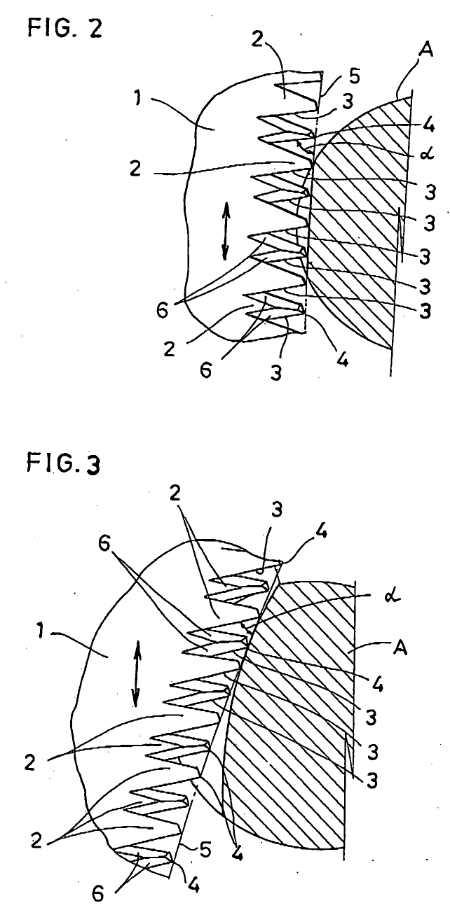

FIG. 1 shows the entire body of the saw blade of the curved saw according to the present invention. FIG. 2 shows the section of a material being cut by the back end of the saw blade of the present invention. FIG. 3 shows the section of a material being cut by the front end of the saw blade.

The saw blade 1 of the curved saw shown in FIG. 1 is a pruning saw used mainly for pruning standing trees and fruit trees.

The saw blade 1, which curves from the back end to the front end, has a multitude of saw teeth 2 formed on its curved and concave edge. The saw teeth 2 are shaped basically the same as conventional saw teeth 2, but the present invention is characterized by the directions in which these saw teeth extend.

More specifically, each of the saw teeth 2 is formed in a triangular shape on the curved and concave edge of the saw blade 1. Every two tooth tips 4 are set in opposite directions from each other, to the left or right of the saw blade, and the material is sawed into two pieces leaving a rift that is equal to the distance between the left and right sets of the tooth tips until the two pieces are completely separate from each other. The concave edge of the saw blade 1 illustrated in the drawing is thicker than the convex edge of the same. The tooth flanks 3 are formed by grinding the side edges of the saw teeth 2, which are formed in semi triangular shapes on the concave edge. Tooth faces 6 forming each tooth flank 3 are established on the left-hand side or right-hand side of each tooth in such a way that a tooth having tooth faces on the left-hand side comes next to a tooth having tooth faces on the right-hand side. The tooth tips 4 on the left-hand side and the tooth tips 4 on the right-hand side are apart from each other by the distance that is within the range of the thickness of the saw blade 1. The tooth tips 4 may also be set to the left or right by bending the tip of each saw tooth 2.

The angles α of the tooth flanks 3 of the semi triangular shaped saw teeth 2 with respect to the edge line 5, which is a virtual line that connects the tooth tips 4, are designed in such a way that those closer to the back end of the saw blade 1 are larger than those closer to the front end of the saw blade 1. The angles α of the tooth flanks 3 with respect to the edge line 5 of the saw teeth 2 formed near the back end of the saw blade 1 are such that they can achieve a good cutting effect when the saw blade 1 is reciprocated along the direction of the edge line.

The angles α of the tooth flanks 3 with respect to the edge line 5 near the front end of the saw blade 1 are smaller than the angles α of the tooth flanks 3 with respect to the edge line 5 near the back end of the saw blade 1, but these angles α, when measured with respect to the tangent line of the edge line 5 near the back end of the saw blade 1, are approximately the same as the angles α of the tooth flank 3 with respect to the edge line 5 near the back end of the saw blade 1. Because the edge, along which the saw teeth 2 of the saw blade 1 are arranged, curves to form a concave line, the tangent line of the edge line near the front end of the saw blade extends in a different direction from the tangent line of the edge line near the back end of the saw blade. The angles α near the front end of the saw blade are made smaller than the angles α near the back end of the saw blade 1 by the difference of the angles by which the tangent lines at the front end of the saw blade 1 and at the back end of the saw blade 1 extend in different directions.

Curved saws of the above construction include various kinds of pruning saws for standing trees and fruit trees, such as a hand-held pruning saw with a handle fixed to the back end of a saw blade, or a high-branch pruning saw with a saw blade fixed to the front end of a long handle. The present invention can be applied in either type of saw.

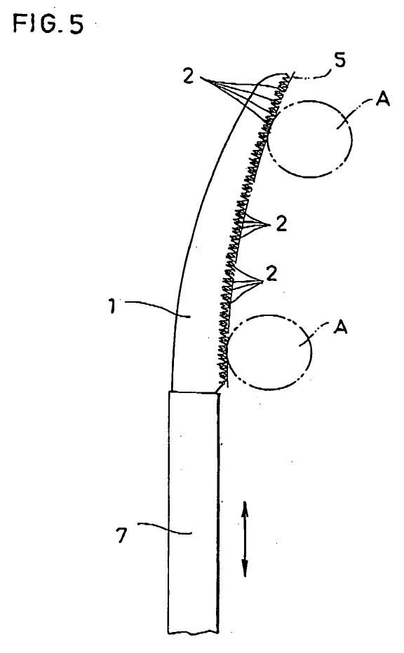

FIG. 5 shows a high-branch pruning saw with a saw blade 1 fixed to the front end of a long handle 7. When using this saw to cut material A that is a branch, the saw blade 1 is reciprocated up and down. The cutting operation of material A proceeds as it reciprocates between the saw teeth at the back end and the front end of the saw blade.

The cutting action at the back end of the saw blade 1 takes place as indicated by an arrow in FIG. 2. The saw blade 1 is moved along the direction in which the edge line 5 extends. At the back end of the saw blade 1, the cutting is performed in the same way as in the case of a straight-blade saw. On the other hand, the cutting near the front end of the saw blade 1 takes place along the direction that the saw blade 1 crosses the edge line 5 of the saw teeth 2 as shown in FIG. 3. Although the cutting takes place along the direction that the saw teeth 2 cross the edge line 5 near the front end of the saw blade 1, the tooth flank 3 of each saw tooth 2 achieves an appropriate cutting angle with respect to the material. In other words, the saw teeth 2 near the back end of the saw blade 1 and the saw teeth 2 near the front end of the saw blade 1 proceed with cutting operations under similar cutting conditions. This reduces variation in cutting resistance, and enables smoother cutting operations over the entire length of the saw blade.

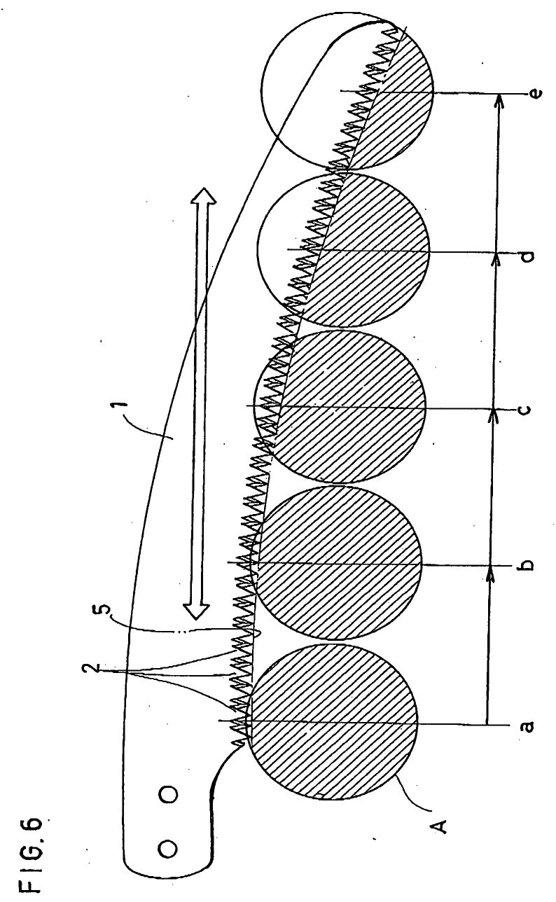

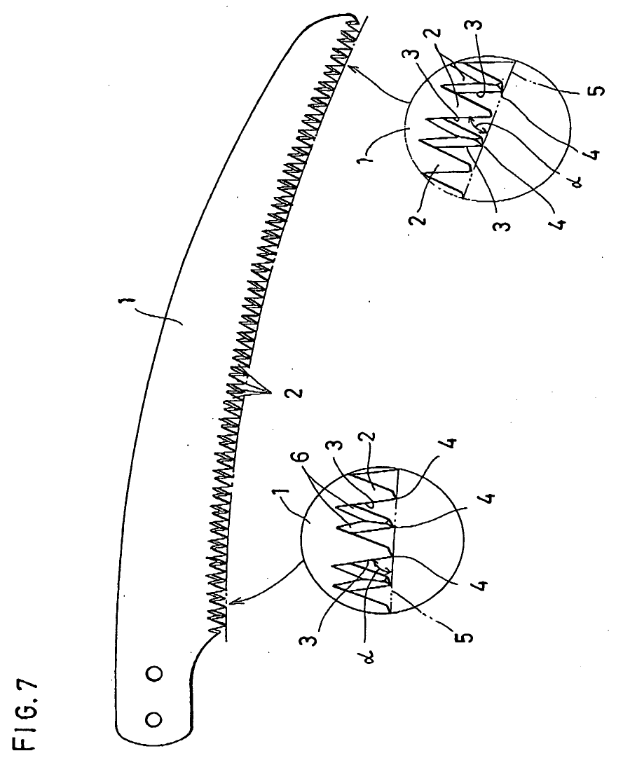

The relationship between the saw and the material at various stages of cutting is shown in FIG. 6. As shown by a white arrow in FIG. 6, the saw blade 1 cuts the material by reciprocating along the direction of the edge line 5 at the back end of the blade 1. The cutting at the back end a is performed in the same way as when a conventional saw is used. When the saw blade 1 is pulled, the contact with the material A, in other words the point at which the cutting load is applied, shifts gradually from a to b, c, d and e. The edge line 5, which connects the tips of the saw teeth 2, curves increasingly downward as it approaches the front end. The saw teeth 2 cuts the material as they move in the direction that crosses the edge line 5, generating the most effective cutting force because of its moving direction.

The inventors of the present invention conducted a comparative experiment in which a timber of a diameter of 80 mm was cut using a pruning saw according to the present invention that has a blade length of 330 mm and a pruning saw of the same length but having a conventional type of saw teeth. In the comparative experiment, in order to avoid artificial operations, the saw blade 1 was reciprocated mechanically.

The experiment showed that the conventional pruning saw could cut the material after thirty-six reciprocations, whereas the pruning saw equipped with the saw teeth of the present invention could cut the material after sixteen reciprocations. While the conventional pruning saw required 31 kilograms of force to reciprocate, the pruning saw according to the present invention needed almost 15 kilograms to reciprocate. It is clear from these findings that a pruning saw equipped with the saw teeth of the present invention can perform pruning more efficiently with a smaller force.

The shape of the saw teeth 2 formed on the concave edge of the curved saw blade 1 is not limited to any particular shape as long as the angles α of the tooth flanks 3 of the saw teeth 2 with respect to the edge line 5, which connects the tooth tips 4 of the saw teeth 2, near the back end of the blade 1 are generally larger than the angles α of the tooth flanks 3 of the saw teeth 2 with respect to the edge line 5 near the front end of the saw blade 1.

More specifically, the angles α of the tooth flanks 3 of the saw teeth 2 with respect to the edge line 5 change progressively from large angles at the back end to small angles at the front end of the saw blade. To achieve this design, in the process of machining saw teeth 2 on a saw blade 1, the entire length of the saw blade is moved in the direction parallel to the direction of the edge line at the back end of the saw blade 1 while at the same time combining movements in directions that cross said parallel direction so that the desired curve is achieved.

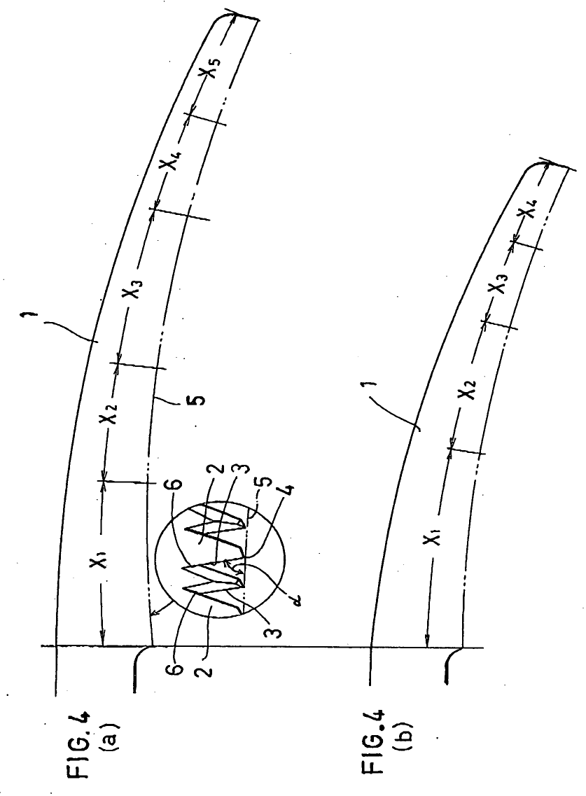

The angles α of the tooth flanks 3 of the saw teeth 2 with respect to the edge line 5 do not necessarily change progressively. In the embodiments shown in FIGS. 4(a) and 4(b), the entire length of the saw blade is divided into several sections—five sections X₁-X₅ in FIG. 4(a) and four sections X₁-X₄ in FIG. 4(b)—and saw teeth having the same angle are formed for each section while varying the angles from one section to another. In this embodiment, well shaped saw teeth can be formed for each section in the same way that saw teeth are formed for a conventional type of saw. The angle α of the tooth flanks 3 of the saw teeth with respect to the edge line 5 for each section can be chosen as appropriate so as to suit the shape and size of the saw blade. In our experiment, we could achieve a well cutting pruning saw by choosing an angle of approximately 77 degrees for the teeth in section X₁ at the back end of the blade and 70 degrees for the teeth in section X₅ at the front end of the blade. In this case, the angles are varied in the following order: 76.5 degrees for section X₂, 76 degrees for section X₃ and 73 degrees for section X₄.

When a curved saw of the present invention described above is used, there is no need to forcefully pull the saw as in the case of a conventional curved saw even when cutting the material using the front end of the saw blade. Good cutting conditions can be achieved over the entire length of the saw blade with a constant force. The situation that the saw teeth near the front end bite into the material and cannot be pulled out can also be avoided. This means that no extra effort is needed to cut the material, while at the same time avoiding the situation that the saw blade breaks or bends. Moreover, because the saw teeth wear evenly over the entire length of the saw blade, you can use the same saw for a longer period of time.

According to the present invention, when the saw blade 1 is pulled in order to perform a cutting operation, the contact point between the material A to be cut and the saw teeth 2 move gradually from the back end to the front end of the saw blade. While maintaining the strong point of the curved saw, which is the ease of maintaining the contact of the material and the saw teeth 2, this invention solves one of the weak points of the conventional curved saw, which is that as the contact point between the material A and the saw teeth 2 is moved toward the front end, the tooth tips 4 act on the material A in such a way that they pierce it, preventing a smooth cutting operation.

When the saw blade 1 is used in order to cut the material A, the saw blade 1 is moved parallel to the direction of the edge line near the back end, but it is moved in the direction that crosses the edge line near the front end of the saw blade 1. Because the tooth flanks cross the edge line, which connects the tooth tips of the saw teeth, at smaller angles near the front end of the saw blade 1 than they do near the back end of the saw blade 1, even when the saw blade 1 is pulled in the direction that crosses the edge line and the contact point is moved closer to the front end of the saw blade 1, the same optimized cutting condition can be accomplished when the contact point is closer to the back end of the saw blade 1.

In addition, according to the present invention, the shapes of the saw teeth change progressively from the back end to the front end of the saw blade, realizing a smooth cutting condition, more specifically a cutting condition with virtually the same cutting resistance, over the entire length of the saw blade.

Furthermore, according to the present invention, the saw is easy to manufacture as it can be made in the same method as conventional curved saws.

1. A curved saw having a curved saw blade that curves from its back end to its front end with a multitude of saw teeth formed on its concave edge, wherein angles of tooth flanks near the back end of the saw blade with respect to an edge line, which connects tooth tips of the saw teeth, are larger than angles of tooth flanks near the front end of the saw blade with respect to the edge line.

2. The curved saw according to claim 1, wherein angles of tooth flanks formed on the concave edge decrease progressively from the largest at the back end of the saw blade to the smallest at the front end of the saw blade.

3. The curved saw according to claim 1, wherein the teeth arranged on the concave edge from the back end to the front end of the saw blade are divided into several sections, and angles of tooth flanks with respect to the edge line, which connects the tooth tips of the saw teeth, are varied from one section to another.
